(19) United States
(12) Patent Application Publication
(10) Pub. No.: US 2025/0128784 A1
(43) Pub. Date: Apr. 24, 2025

(54) TWO-WHEELED VEHICLE

(71) Applicant: Stephen Anvar, Prospect, KY (US)

(72) Inventor: Stephen Anvar, Prospect, KY (US)

(21) Appl. No.: 18/922,012

(22) Filed: Oct. 21, 2024

Related U.S. Application Data
(60) Provisional application No. 63/591,624, filed on Oct. 19, 2023.

(51) Int. Cl. B62K 23/04; B60L 15/20; B62J 43/16; B62K 21/12; B62L 3/02

(52) U.S. Cl. CPC B62K 23/04; B60L 15/20; B62J 43/16; B62K 21/12; B62L 3/02; B60L 2240/421

(57) ABSTRACT

This specification describes a two-wheeled vehicle that is electrically driven and steerable by operation of a rear wheel steering mechanism. The vehicle utilizes a direct drive motor to drive one wheel and may be operated in either direction as desired by a user.

### BACKGROUND OF THE INVENTION

The system described herein relates generally to a two-wheeled apparatus for personal transportation, and more particularly to two-wheeled vehicle that is electrically powered and steerable by operation of a steering and throttle control system that is capable of being operated using only one hand. The present invention features a novel rear wheel steering system that may be reversed to a front wheel system as desired by an operator or user, and low center-of-mass drive construction to provide stability and ease of use and operation.

Small personal vehicles have become highly desirable over the last few decades as demographic trends have seen concentrations of urban dwellers swell. Additionally, the suburban areas around cities have also seen population increases that have increased congestion and traffic issues in many large metropolitan areas. To alleviate congestion and cost, many commuters have turned to small personal vehicles such as scooters, mopeds, golf carts, and other varieties of subcompact cars and the like.

While less expensive than the automobiles that they are designed to replace, many of these personal vehicles are still relatively costly to purchase, and relatively mechanically complex. This complexity comes at a price in maintenance and time required to keep the vehicle in a safe and useful condition. Furthermore, some of these personal vehicles such as golf carts, small mopeds and scooters, and of course subcompact cars, are classified under applicable state regulations such that they require all the attendant state licensure, insurance and inspection requirements that make automobiles inherently expensive and difficult to use, thus obviating some of their utility and increasing cost of operation.

Finally, many of these vehicles while smaller than the average car, still take up a relatively large amount of garage or storage space. Even scooters, while relatively small, are still somewhat difficult to manage in small areas, since they are also relatively heavy and unwieldy to store.

Accordingly, there is a need in the art for a personal vehicle that is simple, easy to operate, relatively inexpensive, and relatively compact and easy to store that is still capable of transporting a person efficiently for short commutes.

### SUMMARY OF THE INVENTION

In various aspects and embodiments the apparatus described herein provides a novel two-wheeled personal vehicle that is easy to operate and store when not in use. The embodiments described herein are capable of being used in a conventional commuting environment, on roads and streets, and within the confines of a city or college campus. A wide variety of embodiments and uses may be employed implementing the apparatus and system of the embodiments described herein, utilizing a variety of structural equivalents without departing from the teachings of this specification.

In some aspects and embodiments vehicle includes a rigid board for supporting a rider, and opposed front and rear wheels mounted for rotation thereto. The vehicle may include a rear wheel driven by an electric motor. The rear wheel may be mounted to a steering post and concomitant yoke for holding an axle that allows the wheel to pivot easily by operation of a steering handle. The steering handle is configured to include a twist throttle and an integral brake lever to provide for one-handed operation from a user.

In various embodiments and aspects a battery is secured in a weatherproof enclosure to provide electric power to a direct drive DC motor for driving at least one wheel of the vehicle. In some embodiments the rear wheel may be driven and in others the front wheel. Furthermore, a brake may be provided on either the front or rear wheel, responsive to the lever control on the steering handle.

In some embodiments the board may be mounted or secured to a rigid frame that also houses or encapsulates the rechargeable battery. In other aspects a battery enclosure disposed proximate the rear wheel of the vehicle is provided to house the rechargeable battery and concomitant throttle and motor controls.

As used herein for purposes of the present disclosure, the terms “two-wheeled vehicle” or “personal vehicle” can be used to refer to any two-wheeled, steerable assembly capable of transporting a user. However any of a wide variety of system and vehicles may be employed with the concepts and embodiments of the invention as taught herein without limiting the scope of the invention.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other advantages and features, which characterize the embodiments, are set forth in the claims appended hereto and form a further part thereof. However, for a better understanding of the embodiments and of the advantages and objectives attained through their use, reference should be made to the Drawing Figures and to the accompanying specification, in which there are described exemplary embodiments. This summary is merely provided to introduce a selection of concepts that are further described below in the detailed description, and is not intended to identify key or essential features of the claimed subject matter, nor is it intended to be used in limiting the scope of the claimed subject matter.

### BRIEF DESCRIPTION OF THE DRAWING FIGURES

In the drawings, like reference characters generally refer to the same parts throughout the different views. Also, the drawings are not necessarily to scale, emphasis instead generally being placed upon illustrating the principles of the invention.

FIG. 1 is a side view of a two-wheeled vehicle in accordance with various embodiments;

FIG. 2 is a partial perspective view of the rear wheel and steering apparatus of a two-wheeled vehicle in accordance with various embodiments;

FIG. 3 is a perspective view of a two-wheeled vehicle in accordance with various embodiments;

FIG. 4 is a partial side view of the rear wheel and steering apparatus of a two-wheeled vehicle in accordance with various embodiments;

FIG. 5 is a partial perspective view of a front axle mount of a two-wheeled vehicle in accordance with various embodiments;

FIG. 6 is a partial side view of a front wheel and board assembly of a two-wheeled vehicle in accordance with various embodiments;

FIG. 7 is an elevation view of a two-wheeled vehicle along the line 6-6 of FIG. 5 in accordance with various embodiments;

FIG. 8 is a partial perspective view of a front wheel and board assembly of a two-wheeled vehicle in accordance with various embodiments;

FIG. 9 is a partial perspective view of a front wheel and board assembly of a two-wheeled vehicle in accordance with various embodiments;

FIG. 10 is an exploded view of a steering handle mount of a two-wheeled vehicle in accordance with various embodiments;

FIG. 11 is a perspective view of a throttle handle mount of a two-wheeled vehicle in accordance with various embodiments;

FIG. 12 is a partial perspective view of a frame assembly of a two-wheeled vehicle in accordance with various embodiments;

FIG. 13 is a perspective view of a frame bracket of a two-wheeled vehicle in accordance with various embodiments;

FIG. 14 is a top view of a two-wheeled vehicle with the board removed in accordance with various embodiments;

FIG. 15 is partial view of a skid plate mounted to the board a two-wheeled vehicle in accordance with various embodiments;

FIG. 16 is partial view of a skid plate mounted to the board a two-wheeled vehicle in accordance with various embodiments; and

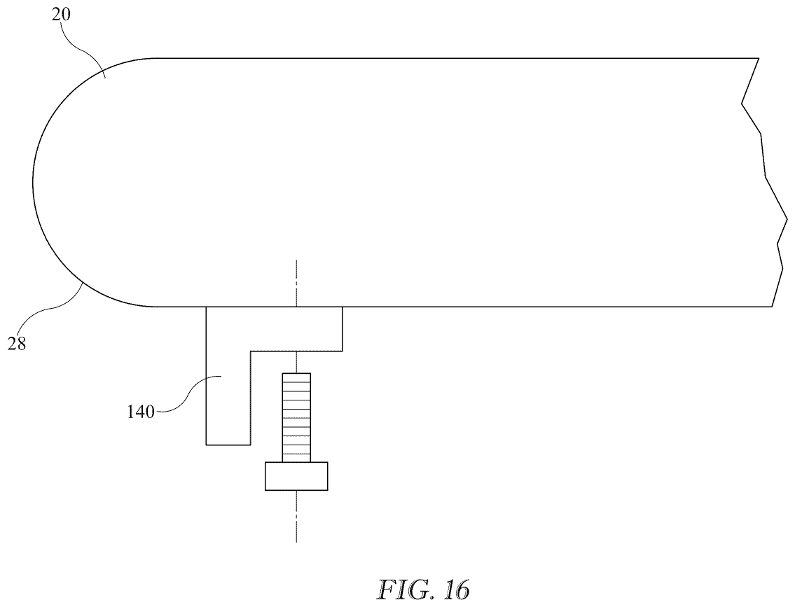

FIG. 17 is a side view of a wheel with an integral motor in accordance with various embodiments.

### DETAILED DESCRIPTION OF THE PREFERRED EMBODIMENT(S)

Numerous variations and modifications of the apparatuses and embodiments of the disclosed land board described in this specification will be apparent to one of ordinary skill in the art, as will be readily seen from the detailed description of the various embodiments set forth below. Therefore, the apparatus is not limited to the specific implementations discussed herein.

Furthermore, the embodiments discussed herein will focus on the implementation of the described techniques and apparatuses for a two-wheeled vehicle. While the embodiments described herein will refer generally to implementation of two-wheeled personal vehicle, one of ordinary skill will recognize that the various inventive concepts may be practiced with a broad array of equivalent assemblies and constructions without departing from the scope thereof.

Referring now to the drawing Figures and in accordance with various aspects and embodiments, herein is described a novel two-wheeled vehicle 10. For example, the embodiments described are capable of being employed and/or adapted for use in a two-wheeled vehicle system designed to incorporate front or rear wheel steering. However, many other embodiments and uses may be employed in implementing the apparatus and system utilizing a variety of structures without departing from the teachings of this specification.

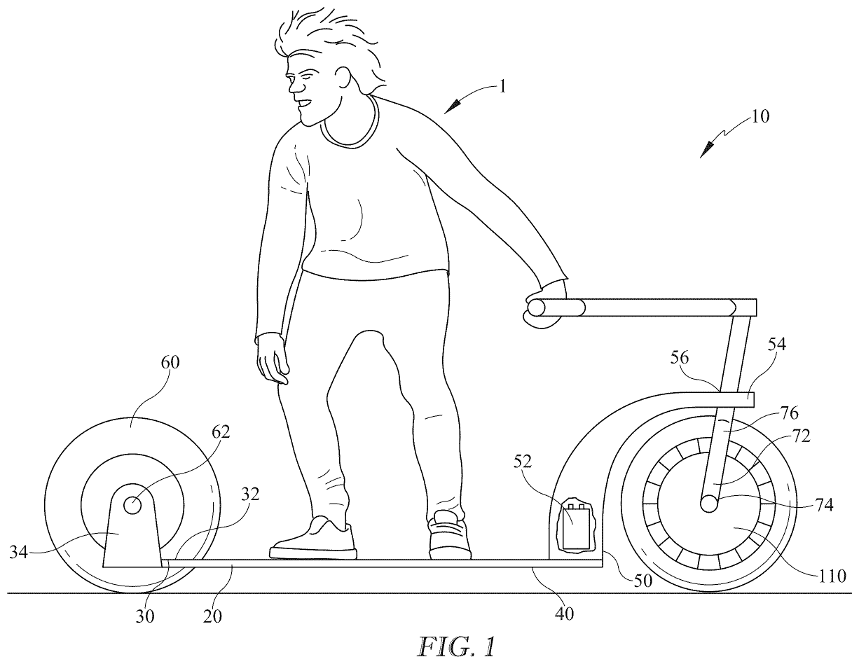

As best seen in FIG. 1, in some aspects and embodiments a two-wheeled vehicle 10 for use by a user or operator 1 can include a board 20, or other relatively flat planar surface that is designed to have sufficient stiffness and length to accommodate user 1 in a standing position. Board 20 includes a front end 30 and rear end 40 respectively, each of which is adapted for securing a wheel for rotation. In some embodiments and aspects vehicle 10 may be referred to as a “land board” 10, due to its similarity in shape and size to a surfboard. Furthermore, board 20 may be constructed of plurality of different lengths and widths and varying wheel sizes depending upon the type of surface or surfaces that a user 1 would like to traverse. The selection of board 20 and wheel size also may be customized to provide specific overall handling and maneuverability characteristics of vehicle 1.

For example, in some exemplary embodiments board 20 may be in the range of 5 to 7 feet in overall length, but shorter and longer boards 10 are contemplated as within the scope of the embodiments described. Board 20 may also be constructed of any relatively rigid material that is optionally weatherproof, and further may include a surface coating or raised surface feature that enhances grip for user's 1 feet while riding vehicle 10. Additionally, as best shown in Fig. xx and in accordance with some aspects board 20 may include a retractable front wheel that that allows user 1 to lengthen or shorten the wheelbase of vehicle 10 as desired to optimize steering feel and ridability.

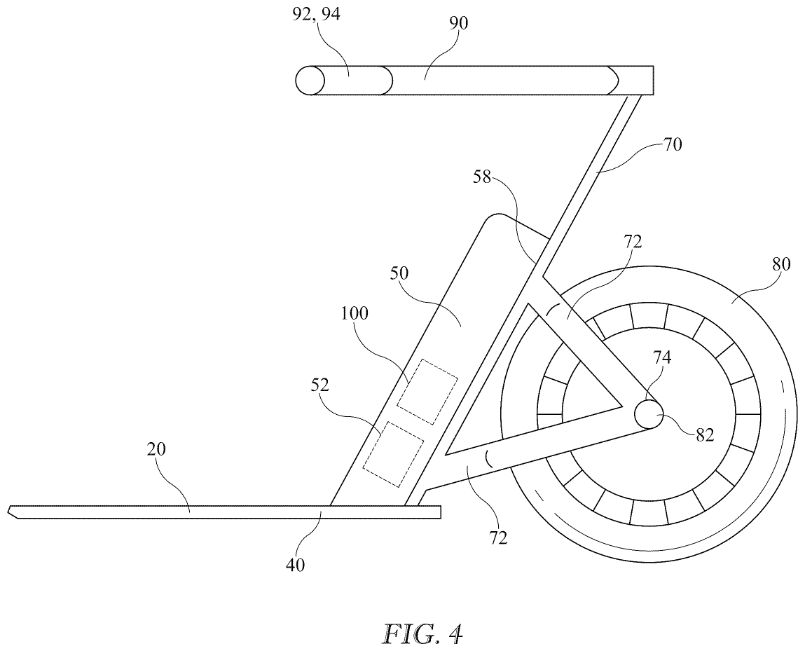

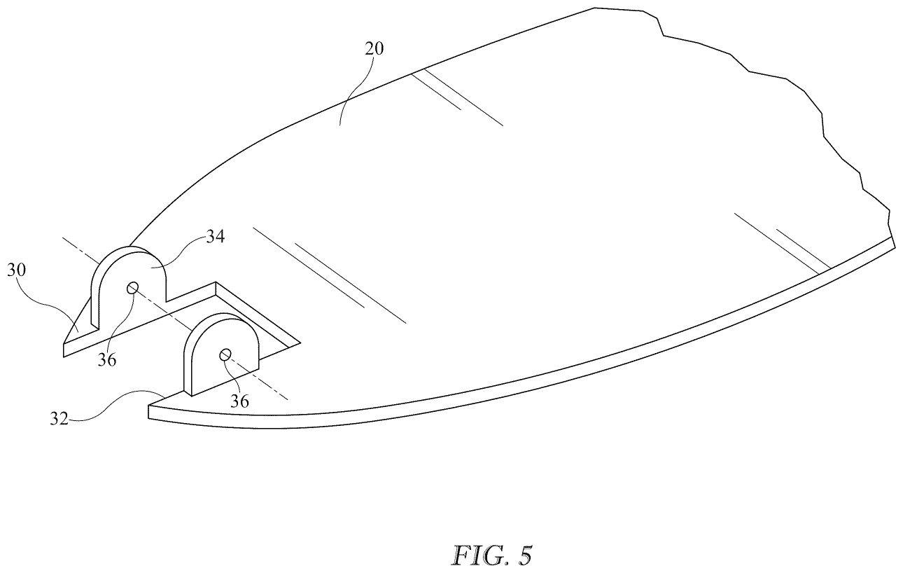

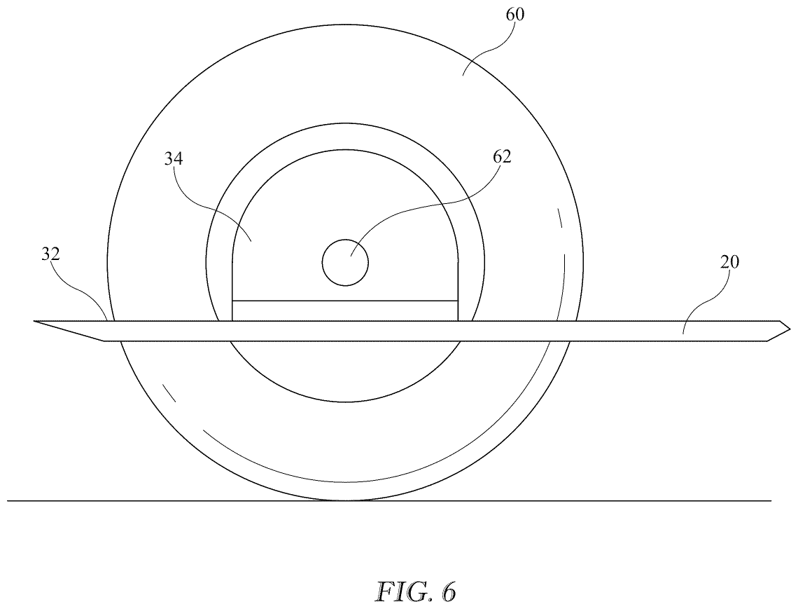

Referring now to FIGS. 1 and 4-9 in various aspects vehicle 10 board 20 may include a slot 32 in front end 30 thereof that is sized to accommodate a front (or first) wheel 60. The front wheel may be journaled for rotation around an axle 62 that is mounted on a pair of opposed axle mounting brackets 34 located on either side of, and above slot 32. Mounting brackets 34 each have an axle aperture 36 therein that accepts axle 62. In some embodiments a suitable sealed bearing (not shown) may be provided to facilitate ease of rotation of wheel 60 around axle 62. In accordance with some aspects positioning axle apertures 36 and thus axle 62 of front wheel 60 above the surface of board 20 provides a vehicle whereby board 20 is lowered relative to the wheel 60 axle 62, thereby lowering the center of gravity of vehicle 1. This feature is highly advantageous for handling purposes.

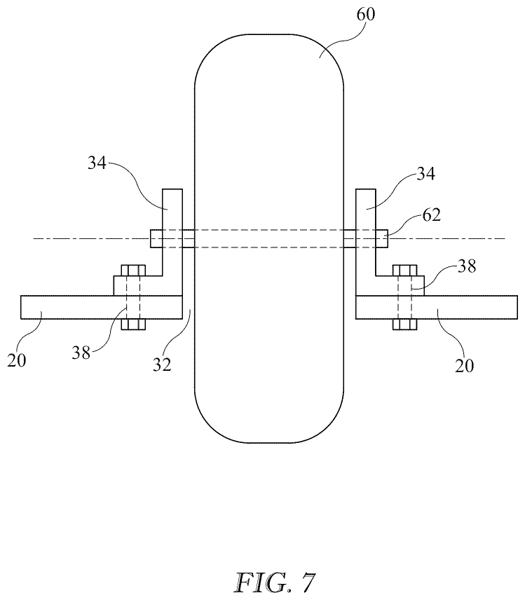

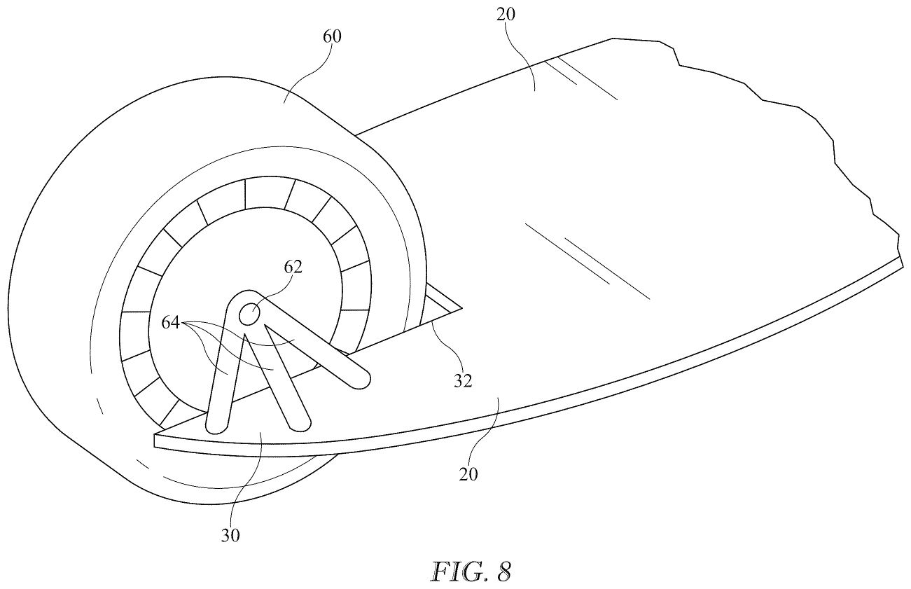

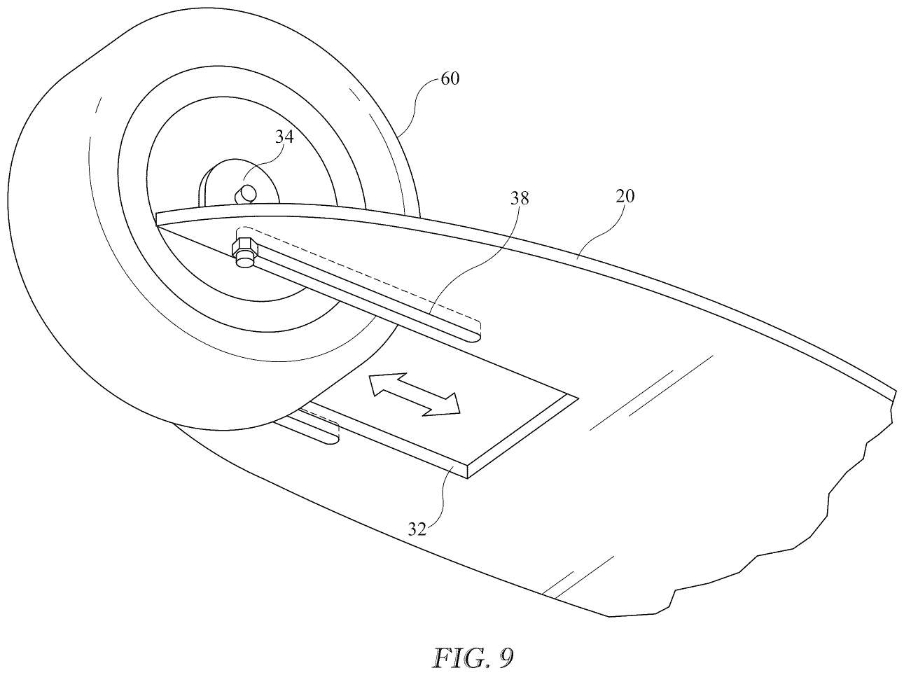

As best seen in FIG. 8 front wheel 60 may be stabilized by utilizing a plurality of struts 64 to mount and secure axle 62. Struts 64 may be secured to axle 62 at a first end and to board 20 at a second end thereof. These embodiments permit board 20 to be vertically positioned at a point below axle 62, thereby lowering the center of gravity of vehicle 1 for superior handling characteristics. In some additional embodiments as best depicted in FIGS. 7 and 9 wheel 60 axle 62 bracket 34 may be mounted in a pair of opposed slots 38 in board 20 front end 30 and secured thereto by a simple fastener, whereby wheel 60 is capable of sliding forwardly and rearwardly to have an extended position and a retracted position. In these embodiments the wheelbase of vehicle 10 may be altered by simply changing the position of wheel 60 by moving axle 62 forwardly or backwardly in opposed slots 38. This feature of the invention permits user 1 to tune handling characteristics of vehicle 10 based on their individual preferences. Additionally, board 20 slot 32 may be sized such that when fully retracted, wheel 60 does not extend past the front end 30 of board 20. When thus retracted, vehicle 10 may be readily stored since board 20 may be leaned against a wall with front end 30 of board 20 on a flat surface. Since wheel 60 is retracted, it won't touch the ground and vehicle 1 won't roll away from the wall.

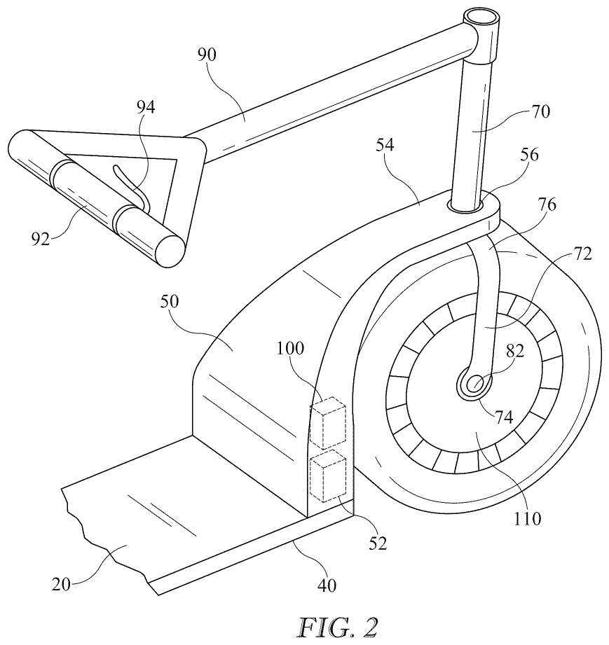

In some aspects and embodiments as best seen in FIGS. 1 and 2 board 20 rear end 40 includes a battery compartment 50 that is sized to encase and protect a rechargeable electric battery 52 that provides power to vehicle 1. Battery compartment 50 may terminate in an upper flange 54 having an aperture 56 therein through which a rotatable steering post 70 is disposed. Of course aperture 56 may include a bearing (not shown) that engages steering post 70, thereby permitting it to easily swivel. Furthermore, in some embodiments battery compartment 50 may have a curvilinear shape along a portion thereof to function as a fender for a rear (or second) wheel 80, thereby protecting user 1 from wheel splash while riding.

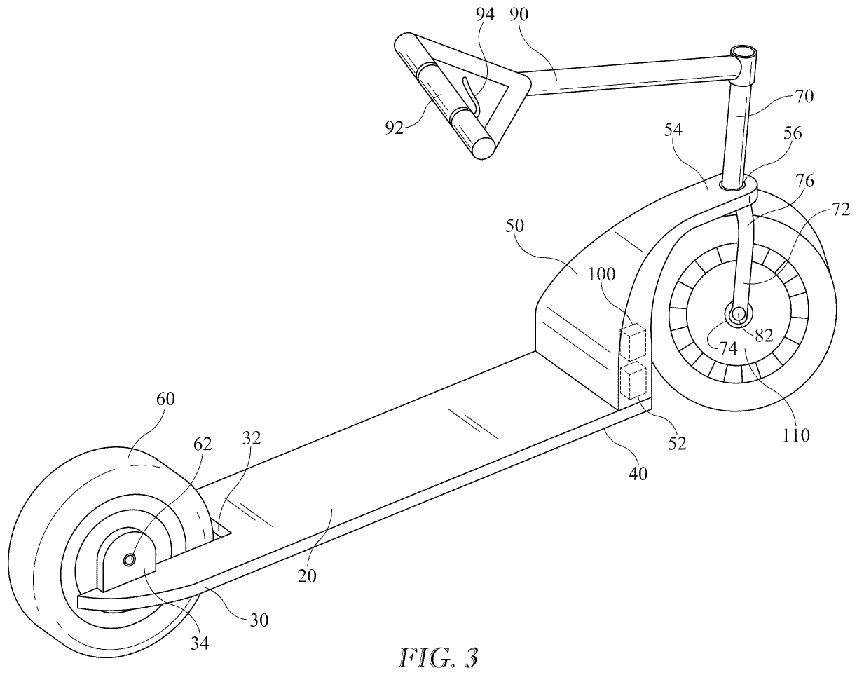

In an alternative embodiment as depicted in FIG. 3, steering post 70 is rotatably mounted along a rear portion 58 of battery compartment 50. In these aspects steering post 70 includes a pair of axle link arms 72 extending therefrom, that terminate in a bearing mount 74 for accepting an axle 82 of rear wheel 80.

In some aspects and embodiments as depicted in FIGS. 1 and 2 and steering post 70 may include a yolk 76 at a lower portion thereof that includes an opposed pair of link arms 72 each having an aperture 74 for accepting axle 82 of rear wheel 80 that is journaled for rotation thereon. Furthermore, a rudder or steering handle 90 is secured to steering post 70 that may in some embodiments include a twist throttle 92 as commonly used in motorcycle applications. In some aspects a lever operated hand brake 94 also depends from a portion of steering handle 90 proximate throttle 92 that enables actuation of a conventional drum or disc brake (not shown) mounted on wheel 80. The unitary steering handle 90 with throttle 92 and hand brake 94 enables user 1 to steer, accelerate and decelerate single handedly, thereby leaving the other hand and arm free for balance. Hand brake 94 may be provided to operate a concomitant disc or drum brake mounted either on front wheel 60 or rear wheel 80, or both as desired.

In a yet further embodiment the throttle 92 may be wired to a motor control unit 100 in battery compartment 50 by routing any required control wiring through steering handle 90 and post 70. In other embodiments throttle 92 may be a wireless controller 92. In these embodiments wireless throttle control 92 could still be mounted and engaged as a “twist” throttle 92. In alternative embodiments and aspects wireless throttle 92 could be a hand-held control that user 1 could operate with the hand that isn't steering. Of course a wide variety of throttles 92 and concomitant throttle 92 controls may be used in conjunction with vehicle 10 without departing from the scope of the disclosed embodiments.

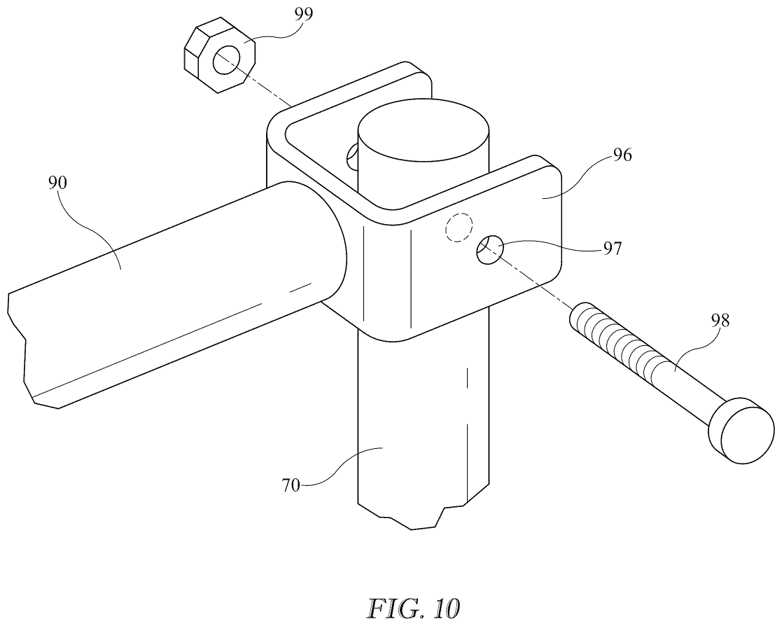

Steering handle 90 may in some embodiments be mounted to steering post 70 by a hinged control arm 96, best shown in FIG. 7 having a u-shape and secured to steering post 70 with a conventional fastener 98, 99 inserted through a pair of apertures 97. Hinged control arm 96 permits user 1 to elevate or lower steering handle 90 as required for comfort and stability. Furthermore, by providing steering handle 90 equipped with an integral throttle 92, brake 94, and direction control of vehicle 10 user 1 may easily control and steer vehicle 1 with one hand, thus allowing user 1 to orient themselves with their feet facing to either side of the board for stability. Thus in some aspects the vehicle 1 may be operated as either a rear steering vehicle or a front steering vehicle, as desired by user 1. In further embodiments as depicted in FIG. 10 steering handle 90 may comprise a single tube 93 that terminates in throttle 92, similar to throttles used on motorcycles.

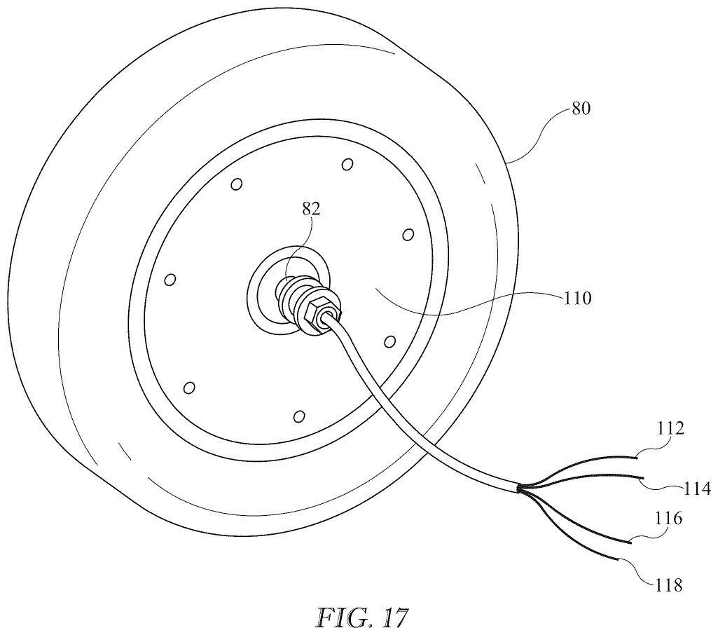

Referring back to FIGS. 1-3 and 17 and in accordance with some aspects and embodiments rear wheel 80 may include a direct drive DC motor 110 mounted to drive rear wheel 80, and thus vehicle 1. Motor 110 may have an output shaft that drives a gear journaled around axle 82, or operatively coupled thereto. In some embodiments, as best depicted in FIG. 17, motor 110 is provided as an integral motor 110 and wheel 80 assembly, having an integral throttle control cable or wire 112 that acts responsive to throttle 92. In these embodiments axle 82 is also integral to motor 110. Additionally, in some aspects an integral brake and brake cable is also included with motor 110 and wheel 80 and may be operatively coupled to hand brake 94.

In some aspects and embodiments motor 110 is operatively coupled to a motor controller 100 housed in battery compartment 50 that is responsive to an input from throttle 92 to control motor 110 speed as desired by user 1. Additionally, in embodiments where motor 110 and wheel 80 are an integral assembly, motor 110 may include motor control wiring 114 that is operatively coupled to controller 100 to provide motor speed control, as well as on/off control, responsive to throttle 92. Battery 50 is electrically coupled to motor 110 to provide a source of power thereto by power wiring 116, 118. Furthermore, in some aspects a drive motor 110, or even a second drive motor 110 may be similarly mounted to drive front wheel 60 of the vehicle.

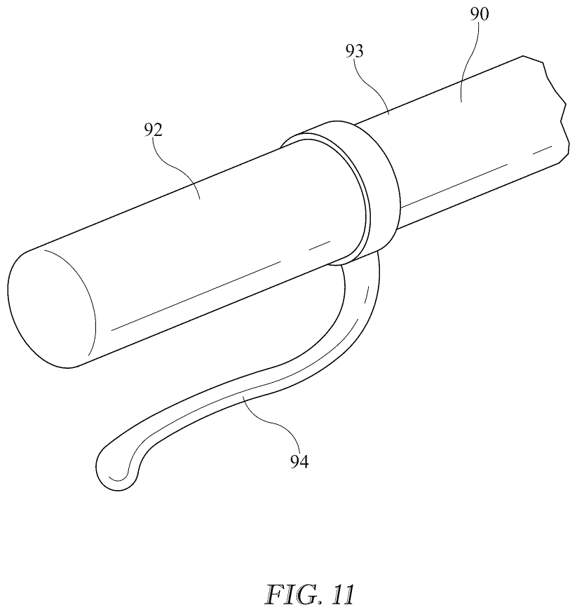

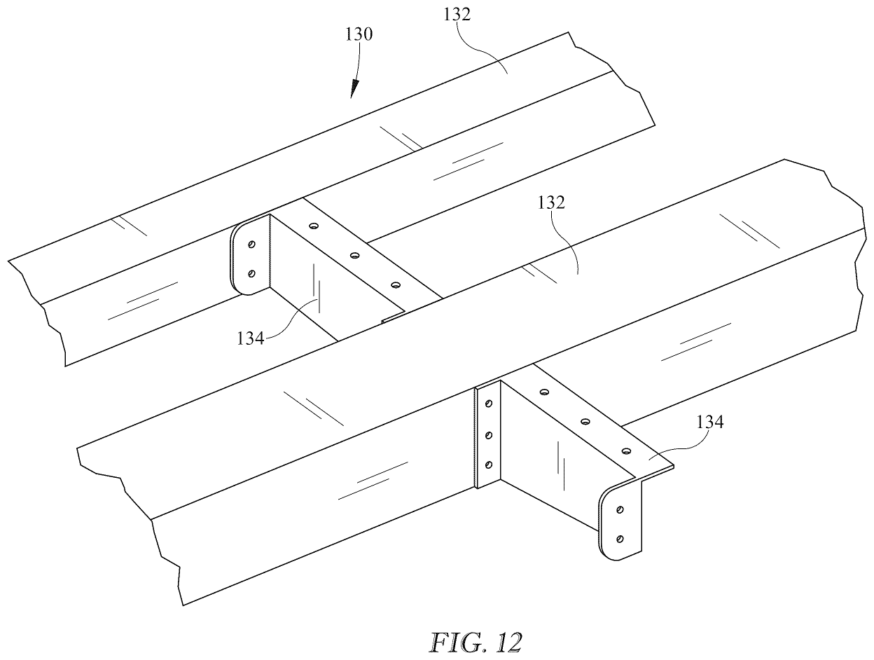

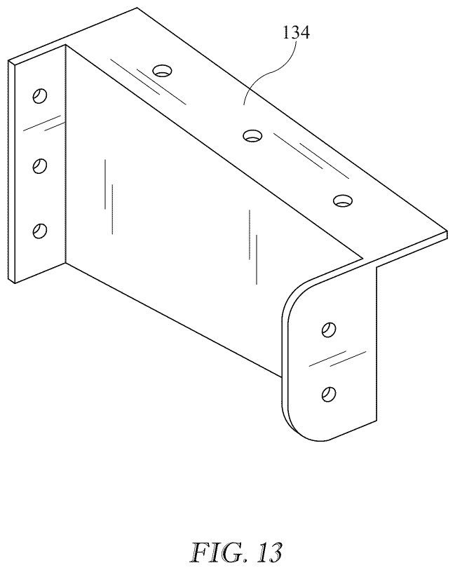

In accordance with some embodiments and as best seen in FIGS. 11-13 board May 20 may be mounted on a frame 130 that supports board 20 and wheels 60, 80 at either end. In these embodiments frame 130 may be constructed from any lightweight, relatively strong material such as aluminum or carbon fiber. Frame 130 may be formed in multiple sections, including longitudinal rails 132 and brackets 134 that are secured to rails 132 with conventional fasteners. In some aspects brackets 134 may be provided and extend from frame 130 for mounting board 20 to frame 130. In these embodiments frame 130 may enclose battery pack 50 whereby rechargeable battery 50 is mounted between the frame 130 rails 132 or sections and protected by a suitable skid plate or panel. These embodiments further reduce the center of gravity of the vehicle, since the weight of battery 50 would be mounted below board 20.

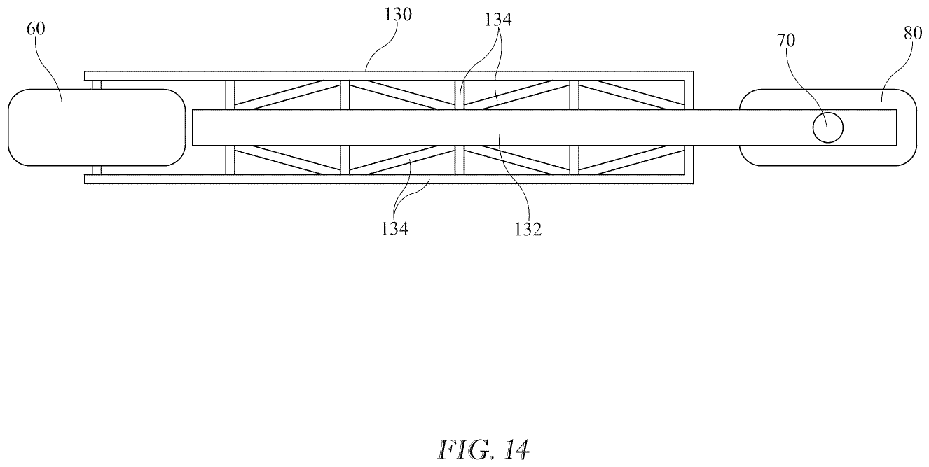

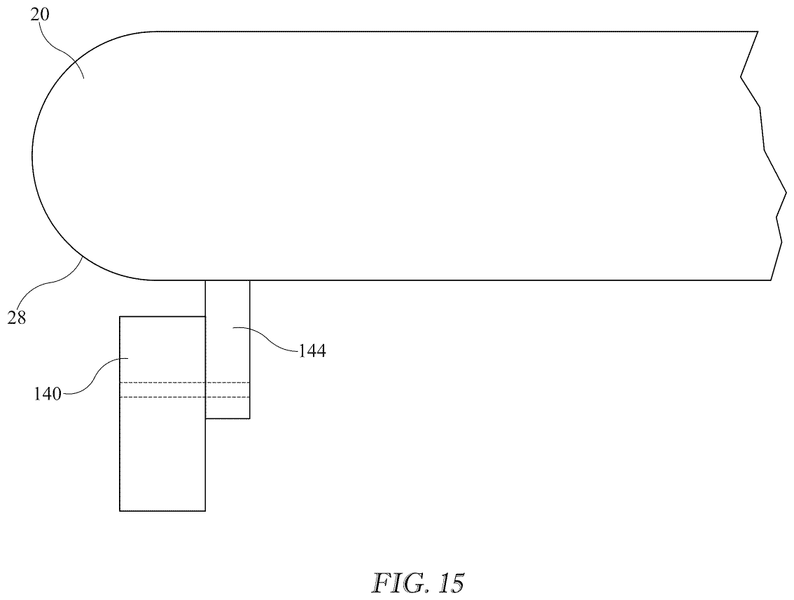

Referring now to FIGS. 14 and 15, in some aspects and embodiments board 20 may include a plurality of small wheels 140 mounted for rotation toward an outer edge 28 of board 20. In these embodiments a plurality of wheels may be secured around the perimeter of board 20 to prevent user 1 from leaning too far to one side or the other and dragging board 20 on the ground, thereby preventing potential falls and injuries. In some further aspects a plurality of skid plates 140, for example secured to a downwardly extending mount 144, may be positioned around outer edge 28 of board 28, also to reduce user 1 injury by preventing board 20 and thus vehicle 10 from leaning too far side-to-side.

In exemplary embodiments vehicle 10 may be operated in “reverse mode”, whereby user 1 may operate vehicle with front wheel 50 steering by simply turning around on the board so that they are facing wheel 80 secured to steering post 70. Since direct drive DC motor 110 may be operated in either direction (reverse or forward), this embodiment may be readily selected and/or configured by user 1 based on individual preference.

In some additional aspects and embodiments board 20 may be relatively short, for example shorter than five (5) feet to position front wheel 60 mounted closer to user 1, thereby providing for a relatively short turning radius. Of course, a wide variety of board 20 lengths and wheelbase lengths may be employed in constructing various embodiments of vehicle 10 depending on the handling characteristics desired by an individual user 1.

While several embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It is to be understood that the embodiments are not limited in its application to the details of construction and the arrangement of components set forth in the description or illustrated in the drawings. The invention is capable of other embodiments and of being practiced or of being carried out in various ways. Unless limited otherwise, the terms “connected,” “coupled,” “in communication with,” and “mounted,” and variations thereof herein are used broadly and encompass direct and indirect connections, couplings, and mountings. In addition, the terms “connected” and “coupled” and variations thereof are not restricted to physical or mechanical connections or couplings.

While the present invention has been shown and described herein in what are considered to be the preferred embodiments thereof, illustrating the results and advantages over the prior art obtained through the present invention, the invention is not limited to those specific embodiments. Thus, the forms of the invention shown and described herein are to be taken as illustrative only and other embodiments may be selected without departing from the scope of the present invention, as set forth in the claims appended hereto.

I claim:

1. A wheeled vehicle comprising:
a generally planar board having front and rear ends;
front and rear spaced wheels respectively mounted for rotation at said front and rear ends of said board;
an electric motor driving said rear wheel;
a steering system having a steering post secured to said rear wheel for rotating said rear wheel and thus steering said vehicle, said steering system further having a control handle secured to said steering post; and
a battery for supplying electrical power to said electric motor.

2. The vehicle of claim 1 comprising:
a throttle control mounted on said control handle for controlling the speed of said electric motor.

3. The vehicle of claim 1 comprising:
a brake control operatively coupled to a one of said front and rear wheels, said brake control mounted on said control handle for braking said vehicle.

4. The vehicle of claim 1 comprising:
a central slot in said front end of said board;
a front axle mounting bracket secured to said board proximate said front end, said front axle mounting bracket accepting said an axle of said front wheel for rotation wherein said front wheel is disposed at least partially in said central slot.

5. The vehicle of claim 4 comprising:
a rear axle mounting bracket secured to said steering post, said rear bracket accepting said an axle of said rear wheel for rotation.

6. The vehicle of claim 5 wherein said front axle mounting bracket is oriented to position said axle of said front wheel vertically above the height of the board, thereby lowering the center of gravity of said apparatus.

7. The vehicle of claim 5 comprising:
a pair of opposed slots disposed in the front end of said board, wherein said front axle mounting bracket is secured in said opposed slots thereby permitting said front wheel to slide between and extended and retracted position.

8. The vehicle of claim 7 wherein the distance between said axles of said first and second wheels is selectable.

9. The vehicle of claim 7 wherein said front wheel does not extend beyond the front end of said board when in a retracted position.

10. The vehicle of claim 3 comprising:
a twist throttle operatively mounted on said control handle, said throttle operatively coupled to a motor control for controlling the speed of said electric motor.

11. The vehicle of claim 10 wherein said twist throttle is operatively coupled by wire to said motor control.

12. The vehicle of claim 10 wherein said twist throttle is wirelessly coupled to said motor control.

13. The vehicle of claim 1 wherein the axis of rotation of said front and rear wheels is disposed above the horizontal level of said board.

14. The vehicle of claim 1 wherein said electric motor is integral to and disposed inside said rear wheel for driving said vehicle.
